(19) United States
(12) Patent Application Publication
(10) Pub. No.: US 2004/0044755 A1
(43) Pub. Date: Mar. 4, 2004

(54) Method and system for a dynamic distributed object-oriented environment wherein object types and structures can change while running

(76) Inventor: Timothy W. Chipman, Ames, IA (US)

Correspondence Address: William J. Brucker, Esq., STETINA BRUNDA GARRED & BRUCKER, Suite 250, 75 Enterprise, Aliso Viejo, CA, 92656, US

(21) Appl. No.: 10/229,251

(22) Filed: Aug. 27, 2002

(51) Int. Cl. G06F 15/173

(52) U.S. Cl. 709/223; 719/315

(57) ABSTRACT

A system and method for a dynamic distributed object-oriented environment wherein object types and structures (representing devices) can change while running are disclosed. The method defines an initial application specific class and creates an object from the initial application specific class. The method then dynamically creates a new application specific class and dynamically transforms the object from the initial application specific class to the new application specific class. The system includes: at least one device server, each device server in communication with a device; a network; and a computer in communication with the device server via the network.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates generally to distributed monitoring and control systems, and relates more particularly to an object-oriented system that processes data and data structures from a plurality of users and devices and allows for the dynamic changing of objects while the system is running.

In a complex technological society, there is an ever-significant need for large numbers of users to access and modify information that is spread across large numbers of computers and electronic devices. As the number of users and information continuously expands, it is common for the structure of information to change over time. Common causes of data structures changing are new uses for organizing data, and new product innovations from device manufacturers.

Most existing systems easily accommodate changes in data across multiple devices and users. However, no known systems to date allow for the structure of data to change without interruption. In most cases, entire systems or portions of systems must be restarted, refreshed, reconfigured, or reprogrammed. A system that allows for the structure of data to change without interruption or intervention should support two fundamental operations:

(1) changing any aspect of the schema of the system; and

(2) changing the classes of existing object instances while running.

In certain systems, it is imperative that all information is continuously accessible while data structures change. In some applications, even a millisecond of interruption is not acceptable.

One application of dynamic object schemas is that of the construction industry. In the construction industry, there are millions of available building components that can be used for many different purposes. In large projects, thousands of people may interact with the same information throughout the architecture, engineering, construction, and facilities management stages. Integrated software can greatly simplify the process by organizing the information in a meaningful way.

In the building design process, there is a compelling need for the ability to interchange individual building components. This can occur at various times and for various reasons, three of which are: (1) during the initial design phase to come up with “what-if” scenarios for cost analysis; (2) at a later time at an owner's request; and (3) at any time due to unexpected changes in component availability.

In an object-oriented software environment, an individual model of a building component is described as a “class”, and an individual occurrence of a component may be described as an “instance,” an “object,” or an “object instance.” For example, the specification for a standard W12×72 steel beam is a class, and a specific W12×72 of a given length and residing at a specific location may be referred to as an instance, an object or an object instance.

It is very useful to be able to change the type of a beam dynamically, such that any attributes that are in common to both the new and old types are preserved, and any external references to the same beam are preserved. For example, it is useful to change a rectangular steel column to a round steel column without having to re-enter or re-evaluate information that is relevant to both, such as the steel strength and fire-protection requirements.

It is also useful to be able to modify schema information in a running system. For example, an electrical contractor may win a bid for a portion of a project, and it is useful for them to cross-reference specified components on a project to company-specific inventory stock numbers. Up until this point, the existing data system was not shared to the electrical contractor and there was no inventory stock number field defined for the contractor. To enable use of the same data model and sharing of the same data with others on the project, the electrical contractor may tack on this custom information to all relevant object instances. This is done by creating an additional class with a “Stock Number” field, and then making this class extend a common “Electric Component” class that was previously defined. Then all existing electric component instances now carry this new field.

Another application of dynamic object schemas relates to the building automation industry. In building automation software, it is useful to interchange components for lighting, climate control, security, entertainment equipment, and other systems in a similar manner. In this scenario, an equipment model is described as a class, and a particular device is described as an instance, an object or an object instance. For example, in the case of switching out an electronically controlled dimmer module, a software object instance exists that represents the dimmer module. It is useful be able to change just the type of the dimmer module while the system is still running, rather than remove, re-create, and re-configure the module, which can cause inconvenience to customers in the event of downtime.

Thus, there is a need for a system and method for a dynamic object-oriented environment with object types and structures that can change while running. Such a system could be used for many applications. Two examples of such applications are the construction industry and the building automation industry.

### BRIEF SUMMARY OF THE INVENTION

It should be noted and understood that with respect to the embodiments of the present invention, the materials suggested may be modified or substituted to achieve the general overall resultant high efficiency. The substitution of materials remain within the spirit and scope of the present invention.

The present invention is directed to a system and method for a dynamic distributed object-oriented environment wherein object types and structures can change while running. The objects represent devices that are components of a networked system.

The method includes the following steps: (1) defining an initial application specific class; (2) creating the object from the initial application specific class; (3) dynamically creating a new application specific class; and (4) dynamically transforming the object from the initial application specific class to the new application specific class.

The system may include multiple application specific classes and multiple objects. The method may further include the steps of: (5) defining a parent object for the object; and (6) arranging the objects in an object hierarchy based off of the parent object.

The object hierarchy can be modified in a running system while preserving referential data integrity. The object hierarchy can be modified using a set of fundamental actions which include: creating a new object; deleting one of the objects; setting a field on one of the objects; clearing a field on one of the objects; moving one of the objects by changing the object's parent and/or the object's position among siblings; and transforming one of the objects by changing the object's application specific class.

The fundamental actions may be nested into a transaction which ensures that either all actions in the transaction are completed or that none of the actions in the transaction are completed so that data integrity is guaranteed in the event of a failure, such as a network failure or a power failure. Additional actions may include opening a transaction and closing a transaction

All actions are logged to enable auditing of the networked system so that the networked system may be restored to a state at a given point in time.

A complete save may be performed by periodically saving the state of the networked system to non-volatile storage, and an incremental save may be performed by saving the actions to non-volatile storage immediately as processed so that the current system state of the networked system can be restored by re-applying the actions of the incremental save that occurred since the last complete save.

The state of the networked system can be restored to the state at the given point in time by generating equal and opposite actions to cancel the effect of each action that is to be reversed.

Multiple systems may be networked together to share views of the same object hierarchy, and such data changes are replicated between machines over a network. The replication may be: (a) a client-server topology wherein nodes defined as clients replicate changes to a server, and a server node replicates changes back to all clients; (b) an

n-tier topology wherein server nodes can also be client nodes to other servers, forming a hierarchy of state replication; (c) a broadcast topology wherein nodes broadcast changes to the networked system where other nodes listen for such changes; (d) a chain topology wherein each node replicates changes to one other node, forming a circle of nodes; or (e) a redundant topology wherein nodes are clustered together such all nodes within a cluster replicate state amongst themselves and if one node fails, then another node assumes its place.

A network protocol is used to accomplish the object hierarchy modification. The network protocol may be an industry standard protocol or a proprietary protocol. The network protocol may be a data-centric protocol or a presentation-centric protocol.

A web site may be automatically generated to reflect contents of the object.

A C-based application may be used to implement the method.

Objects are represented using a data structure. The data structure may include: (a) a globally unique identifier, used to uniquely identify the object within the networked system; (b) a name used for referring to the object; (c) if the object is not a top-level root object that does not have a parent, a parent object used to arrange the object within a hierarchy of objects; (d) a path for addressing the object by describing its placement within the hierarchy of objects; (e) a class defining a type of the object; (f) at least one field that describes a current data setting; and (g) at least one property, wherein each property defines a field and the property is defined as a child object of the class where it resides, wherein each field is mapped to a respective property.

The system used to implement the method for representing an object in a networked environment includes: a device server in communication with a device; a network; and a client computer in communication with the device server via the network. The device server and the client computer each have an initial application specific class defined that includes properties that are representative of the device and an object instance of the initial application specific class. A new application specific class can dynamically be created to represent a change in the device and the object instance can dynamically be transformed from the object instance of the initial application specific class to an object of the new application specific class. For example, a new application class may be created on the client computer.

The client computer includes a display for displaying a user interface that allows a user to view at least one of the properties that are representative of the device and/or to enter data for at least one of the properties that are representative of the device, wherein the entered data is sent to the device via the device server.

The system may include a plurality of device servers with each device server in communication with a respective device.

The system may include a touchpad in communication with the device server. The touchpad is configured to remotely communicate with the device.

The network may be an ethernet network, a serial network, a wireless network, or an infrared network.

### BRIEF DESCRIPTION OF THE DRAWINGS

These as well as other features of the present invention will become more apparent upon reference to the drawings wherein:

FIG. 1 is a simplified block diagram of an exemplary distributed climate control system;

FIG. 2 is a flow diagram illustrating exemplary logic implemented on a device server for a dynamic distributed object-oriented environment having dynamic object types and structures;

FIG. 3 is a flow diagram illustrating exemplary logic for defining application specific classes;

FIG. 4 is a flow diagram illustrating exemplary logic implemented on a personal computer for a dynamic distributed object-oriented environment having dynamic object types and structures; and

FIG. 5 is an exemplary display of an automatically generated web interface for a distributed climate control system such as the one shown in the exemplary block diagram of FIG. 1.

### DETAILED DESCRIPTION OF THE INVENTION

A system and method for a dynamic distributed object-oriented environment with object types and structures that can be changed while running is disclosed. The example shown and described herein relates to the building automation industry. Specifically, the simplified example shown and described relates to the climate control aspects of building automation. More specifically, the example shown and described is a climate control system having two thermostats. It will be appreciated that this simplified example was provided for ease of description only and is not intended to be limiting. For example, the climate control system may include additional components and a building automation application may also include lighting control components, security components, entertainment equipment, etc. A building automation system could allow a family to control lighting components, security components, HVAC devices and entertainment equipment all through a single interface, rather than through individual front panels and/or remote controls for each device. As described later, the disclosed system allows for new devices to be added or removed without interrupting the system. Lights and thermostats can be controlled based on schedules and occupancy of the building (e.g., house or office). The system can be configured for remote access. This allows for the notification of alert anywhere. The system could be used for applications other than building automation applications, for example, distributed order-entry systems that consist of parameter-based product specifications and industrial control systems based on modular components that are re-configured while running to produce product variations.

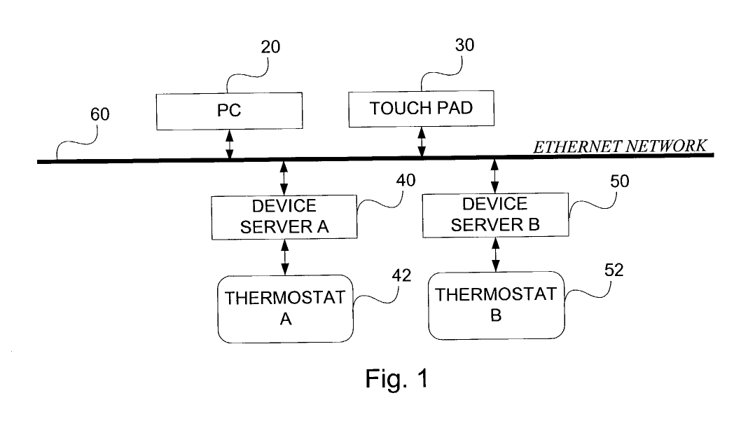

Referring now to the drawings wherein the showings are for purposes of illustrating preferred embodiments of the present invention only, and not for purposes of limiting the same, FIG. 1 is a block diagram illustrating components for a climate control system. The climate control system may be a subset of a building automation system. In this specific embodiment, an area, such as an office complex, has two thermostats that are connected to an Ethernet network 60, where a computer 20, such as a PC, and a handheld electronic device 30 are used to access and control the thermostats 42, 52 remotely.

In one embodiment, an RCS TR15 manufactured by Residential Control Systems Inc. of Rancho Cordova, Calif. is used for each thermostat control unit, and an RCS TS15 manufactured by Residential Control Systems Inc. of Rancho Cordova, Calif. is used for each thermostat wall display unit. These thermostats function as standard thermostats and also allow remote commands to set specific temperature setpoints and heating, ventilation & air conditioning (HVAC) modes. The wall unit has buttons for mode, fan and changing the setpoint. The HVAC control unit maintains temperature control and receives updates from the wall display unit for changes in temperature and/or inputs received via button presses. The HVAC control unit also receives remote commands over a network interface, for example, an X.10, RS-232/RS48S, CEBUS or Lon Works network.

A Lantronix UDS100 serial-to-Ethernet device server manufactured by Lantronix of Irvine, Calif. is used to bridge each thermostat to the Ethernet network. It consists of an RS-232 serial port, an RJ45 Ethernet port, a 16-bit processor, 2 gigabytes of flash memory, and 256K random access memory (RAM). It is encompassed within a case that is about the size of a deck of cards.

A computer 20 is used to access information gathered by the thermostats 42, 52 such as historical logs of temperature readings. The computer 20 is also used to configure schedules and energy-saving mechanisms throughout the system of thermostats.

Preferably, the computer 20 is a personal computer (PC). In preferred embodiments, the PC 20 is running Windows XP®. It will be appreciated that other operating system could be used, for example, the computer could be a PC 20 running a Windows® operating system other than Windows XP®, for example, Windows® 95™, Windows® 98™, Windows ME®, etc. The computer 20 may be a type of computer other than a PC, for example, the computer 20 could be a Sun® computer running a Unix® based operating system. It will be appreciated that the computer and operating system being used could be any computer and operating system known now or developed in the future that has sufficient resources for running the programs within any timing constraints imposed by the particular application.

A touchpad 30, for example, a ViewSonic ViewPad 100 wireless remote touch pad manufactured by ViewSonic of Walnut, Calif. may be used by occupants of the office complex to remotely adjust the thermostats 42, 52. This touchpad 30 contains software on-board that includes a web browser that can access either of the device servers 40, 50. The touchpad 30 interfaces to the device servers 40, 50 in the same manner as a PC web browser. The touch-screen input is interpreted as mouse-based control and the touch-screen output is generated by a VGA video signal.

A software program is written to run on each device server 40, 50 and a software program is written to run on the computer 20. In exemplary embodiments shown and described later, the C computer language and standard C libraries are used for the software programs.

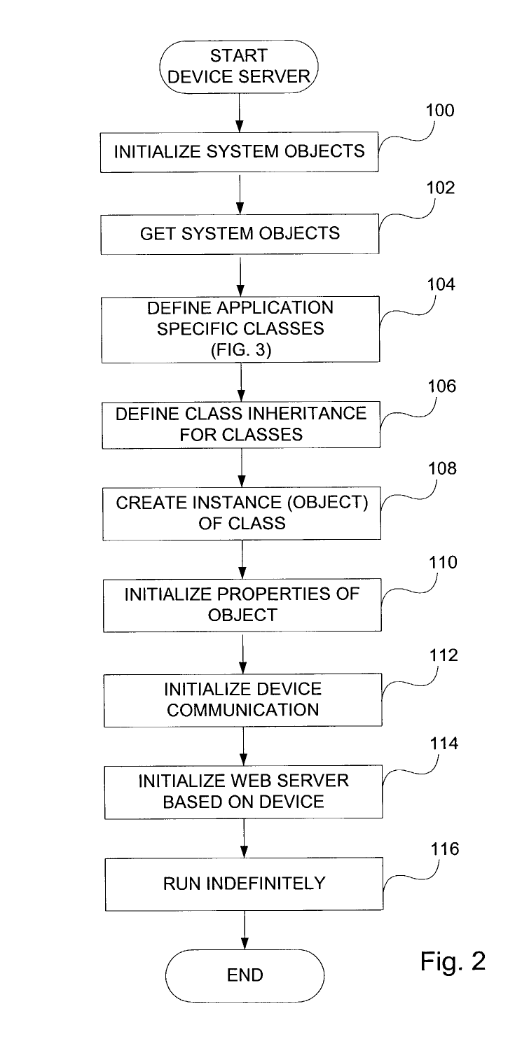

FIG. 2 is a flow diagram illustrating exemplary logic to be run on a device server 40, 50 for a dynamic distributed object-oriented environment having dynamic object types and structures. The logic of FIG. 2 moves from a start block to block 100 where system objects are initialized. Initialization of the system objects includes: building a minimum schema required for execution of the program, setting common properties, defining generic relationships and naming system objects.

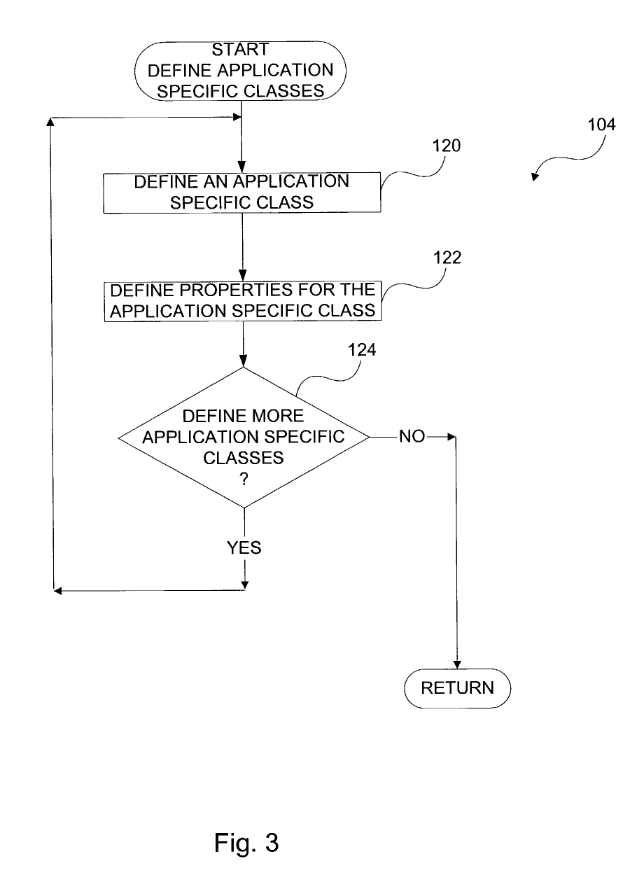

The logic proceeds to block 102 where system objects are retrieved. The logic then proceeds to block 104 where application specific classes are defined. Exemplary logic for defining application specific classes is shown in FIG. 3 and described next.

The logic of FIG. 3 for defining application specific classes moves from a start block to block 120 where an application specific class is defined. For example, in the climate control example, a climate control class is defined.

The logic then moves to block 122 where properties are defined for the application specific class. In the case of a climate control class, the properties may include a fan, a setpoint and a current temperature. The fan property may be a boolean value indicating whether the fan is on or off. The setpoint indicates the desired temperature.

The logic then proceeds to decision block 124 to determine if there are more application specific classes to be defined. If so, the logic returns to block 120. In the current example, after the climate control class and properties have been defined, a thermostat class may be defined. As described below, the thermostat class may be derived from the climate control class. Thus, the thermostat class has all of the properties defined by the climate control class, e.g., fan, setpoint and current temperature. Additional properties specific to the thermostat class could also be defined. The logic of blocks 120-122 is repeated until all of the application specific classes have been defined. When all of the application specific classes have been defined (no in decision block 124), the logic of FIG. 3 ends and processing returns to FIG. 2.

Returning to FIG. 2, after the application specific classes have been defined, the logic moves to block 106 where inheritance is defined for the classes. Inheritance provides a hierarchical structure for the objects. As stated above, in the climate control application, the thermostat class is derived from the climate control class, i.e., the climate control class is the parent of the thermostat class. The thermostat class (child) includes all of the properties of the climate control (parent) class.

The logic proceeds to block 108 where an instance of a class (object) is created. In the example shown, the software running on Device Server A 40 would instantiate an instance or object representing Thermostat A 42 and the software running on Device Server B 50 would instantiate an instance or object representing Thermostat B 52.

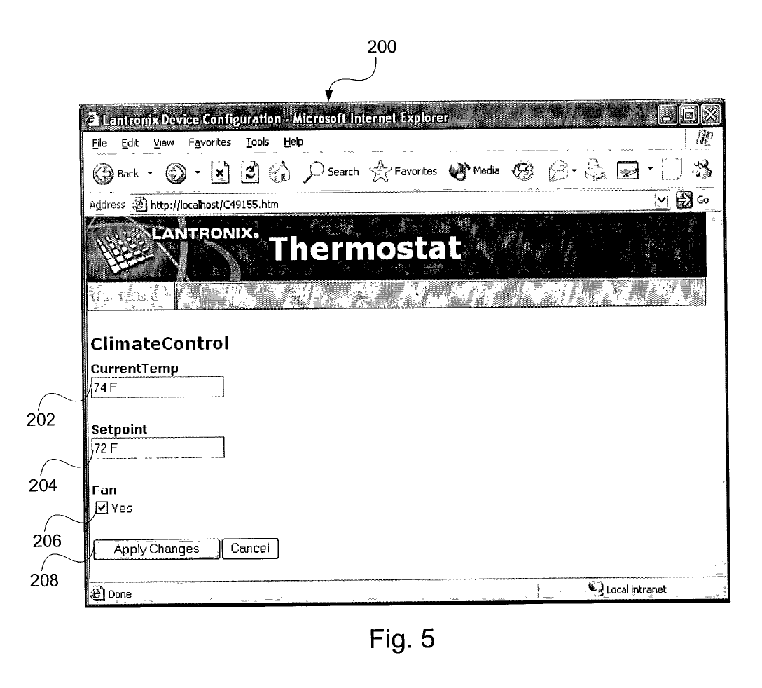

The logic proceeds to block 110 where the properties of the object are initialized. For example, a value is set for the fan (whether or not to turn on the fan) and a desired temperature (setpoint) is provided. Preferably, default values are provided. The default values can be overridden by the user, for example, by using the computer 20 to set new values. An interface, such as the one shown in FIG. 5, may be used for the user to enter new values.

The logic moves to block 112 where device communication is initialized. In the example shown, device communication is established between a device server 40, 50 and the device 42, 52 that is controlled by the device server 40, 50. In the example shown, if the software running is on Device Server A 40, communication is established between Device Server A 40 and Thermostat A 42 and if the software running is on Device Server B 50, communication is established between Device Server B 50 and Thermostat B 52.

The logic then moves to block 114 where a web server is initialized based on the device. The web server provides a user interface for the user to set various parameters to control the device. The logic then moves to block 116 where the logic runs indefinitely. The logic of FIG. 2 ends if the logic of FIG. 2 is stopped, for example, by turning off power to the device server.

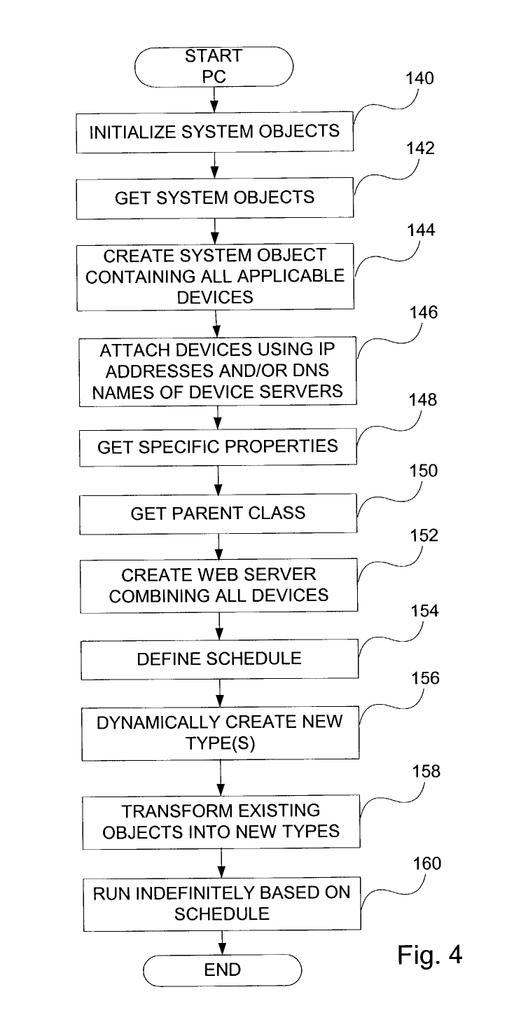

FIG. 4 is a flow diagram illustrating exemplary logic to be run on a computer 20 for a dynamic distributed object-oriented environment having dynamic object types and structures. The logic running on the computer 20 runs in conjunction with the logic shown in FIGS. 2-3 which is running on the device servers 40, 50. The logic of FIG. 4 provides a common user interface between a user and all of the devices 42, 52, via their device servers 40, 50. Thus, the user can check status and/or set values on any or all of the devices 42, 52 via the computer 20.

The logic of FIG. 4 moves from a start block to block 140 where system objects are initialized. The logic then proceeds to block 142 where system objects are retrieved. A system object is created containing all applicable devices. See block 144. In the example shown, a system object is created that contains both thermostats 42, 52. The remote devices 42, 52 are then attached. A remote device may be attached using an IP address or a DNS name. See block 146.

The logic proceeds to block 148 where specific properties are retrieved. In the example shown, this can include any or all of the properties (fan, setpoint, current value) for one or both of the thermostats 42, 52. The logic moves to block 150 to retrieve the parent class. A webserver that combines all of the devices (thermostats 42, 52) is created. See block 152.

The logic proceeds to block 154 where a schedule is defined. For example, an energy conservation schedule may be defined. If the climate control system is that of an office complex, energy may be saved by not turning on the air conditioner or heater during non-working hours. In the case of a home system, energy may be saved by turning off the air conditioner and heater when the house is unoccupied.

New types may dynamically be created and existing objects may be transformed from their existing types to new types (including the new dynamically defined types). See blocks 156 and 158. For example, a “userhold” property may be desired to suppress automatic adjustment from the programmatic schedule. A new type of thermostat class (e.g., custom thermostat) can be created which includes the userhold property. This class can be derived from the climate control class. If the class is derived from the climate control class, it will have all of the properties of the climate control class (e.g., fan, setpoint, current temperature) in addition to the properties (userhold) defined in the new custom thermostat class. Existing objects (instances) of thermostats can be transformed to the new custom thermostat type which was dynamically created. When the instance is transformed to the new type, common properties are not changed. In the current example, the properties of fan, setpoint and current temperature are properties in both the old type and the new type and are therefore common properties. These values remain unchanged. Any new properties, such as userhold, are initially set to a default value. Any properties of the old type which are not in the new type are cleared. Even though the object (instance) type was changed, everything remains running without interruption. Existing attributes (e.g., setpoint) remain unchanged.

The logic proceeds to block 160 where the logic runs indefinitely based on the schedule defined in block 154. In the example shown, values are repeatedly set and checked at predetermined intervals. For example, if the time changes from working hours to non-working hours or from non-working hours to working hours, values may be set accordingly, for example, the fan may be turned off or on, respectively. As with the logic running on the device servers 40, 50 shown in FIG. 2, the logic of FIG. 4 may be ended, for example, by ending the program and/or stopping/disrupting power to the PC 20.

The exemplary logic for a climate control system such as the one shown in FIG. 1 to be run on the device server 40, 50 as shown in FIGS. 2-3 and described above may be implemented using the exemplary C language source code shown below:

```
int main (int argc, char *argv[])
{
  // system objects
  struct LX_OBJECT* pTypeClass; // the “class” class
  struct LX_OBJECT* pTypeBoolean; // boolean class
  struct LX_OBJECT* pTypeTemp; // temperature class
  struct LX_OBJECT* pSerialPort;
  // custom objects
  struct LX_OBJECT* pClimateClass;
  struct LX_OBJECT* pThermostatClass;
  struct LX_OBJECT* pFanProperty;
  struct LX_OBJECT* pCurrentTempProperty;
  struct LX_OBJECT* pSetpointProperty;
  struct LX_OBJECT* pThermostatInstance;
  // initialize system objects
  LxSystemInit ( );
  // get system objects
  LxGetObjectByPath (NULL,  “Schema/System/Class”,
&pTypeClass);
  LxGetObjectByPath (NULL,  “Schema/System/Boolean”,
&pTypeBoolean);
  LxGetObjectByPath (NULL,
“Schema/System/Units/Temperature”, &pTypeTemp);
  LxGetObjectByPath (NULL,  “Devices/Serial/COM1”,
&pSerialPort);
  // create application-specific objects
  // create a Climate Control class
  LxCreate (pTypeClass, NULL, NULL, NULL,
“ClimateControl”, &pClimateClass);
  // create several properties for the Climate Control
class
  LxCreate (pTypeBoolean,  pClimateClass,  “Fan”,
&pFanProperty);
  LxCreate (pTypeTemp,  pClimateClass,  “Setpoint”,
&pSetpointProperty);
  LxCreate (pTypeTemp,  pClimateClass,  “CurrentTemp”,
&pCurrentTempProperty);
  // create a thermostat class
  LxCreate (pTypeClass, NULL, NULL, NULL, “Thermostat”,
&pThermostatClass);
  // make the thermostat class derive from the climate
control class
  LxClassInherit (pThermostatClass, pClimateClass);
  // create an instance of the thermostat
  LxCreate (pThermostatClass,  NULL,  “ThermostatA”,
&pThermostatInstance);
  // initialize properties of the thermostat (fan is on,
setpoint is 22 C)
  LxSetPropertyBool (pThermostatInstance, pFanProperty,
TRUE);
  LxSetPropertyText (pThermostatInstance,
pSetpointProperty, 22.0);
  // initialize device communication with the thermostat
  LxRunDeviceDriver (pThermostatInstance,  pSerialPort,
TheCustomDriverFunction);
  // initialize web server based on the thermostat
  LxRunWebServer (pThermostatInstance);
  // keep running indefinitely
  LxRun ( );
  return 0;
}
```

The exemplary C language source code shown above runs on each device server 40, 50 and generates a web interface 200 such as the one as shown in FIG. 5 which is displayed on computer 20. The exemplary web interface 200 shown in FIG. 5 allows a user to set the parameters for the thermostats 42, 52. In the example shown, the current temperature is displayed 202. The user can enter a desired temperature, i.e., setpoint 204. The user can also turn the fan on or off 206.

The user can access a web interface for any device in the system using computer 20. For example, a main web interface may provide a user with a list of subsystems, such as HVAC devices, lighting devices, security devices, entertainment devices, etc. The user can then select a desired subsystem, such as HVAC. A display of available devices for the subsystem is displayed. The user can then select a device, for example, Thermostat A 42 or Thermostat B 52. A web interface 200 for the specific device is then displayed.

The user enters the desired values (control information) using the web interface 200. The information is transmitted when the user requests transmission of the information by pressing an “apply changes” button 208. The information is then transmitted from the PC 20 over the Ethernet network 60 to the appropriate device server 40, 50. The device server 40, 50 then transmits the control information to the respective device (e.g., thermostat 42, 52).

The remote touch pad may be used to connect to either of the device servers 40, 50 to display the web interface as shown in FIG. 5.

The computer 20 may serve as a scheduler for the thermostats 42, 52 and set the temperature according to a fixed schedule. The application running on the computer 20 extends the schemas of the applications running on each device server 40, 50. It also changes the thermostat object types on the device servers 40, 50 while running, in order to add extra functionality in the form of a “User Hold” feature. This feature, when enabled, allows users to set the thermostat manually such that the automatic scheduling is temporarily disabled.

The logic for a climate control system such as the one shown in FIG. 1 to be run on the computer 20 as shown in FIG. 4 and described above may be implemented using the exemplary C language source code shown below:

```
int main (int argc, char *argv[])
{
  struct LX_OBJECT* pTypeClass;
  struct LX_OBJECT* pTypeBoolean;
  struct LX_OBJECT* pThermostatA;
  struct LX_OBJECT* pThermostatB;
  struct LX_OBJECT* pHVACSystem;
  struct LX_OBJECT* pSetpointProperty;
  struct LX_OBJECT* pClimateClass;
  struct LX_OBJECT* pCustomThermostatClass;
  struct LX_OBJECT* pHoldProperty;
  int nHour;
  int nMinute;
  int nSecond;
  float setpoint;
  BOOL bHold;
  // initialize system objects
  LxSystemInit( );
  // get system objects
  LxGetObjectByPath(NULL,  “Schema/System/Class”,
&pTypeClass);
  LxGetObjectByPath(NULL,  “Schema/System/Boolean”,
&pTypeBoolean);
  // create an HVAC System object that contains both
thermostats
  LxCreate(NULL, NULL, “HVAC System”, &pHVACSystem);
  // attach remote thermostats to the HVAC system
  // text specifies the IP address or DNS name of the
device servers
  LxAttachRemoteObject(pHVACSystem,
“DeviceA.mydomain.com”, &pThermostatA);
  LxAttachRemoteObject(pHVACSystem,
“DeviceB.mydomain.com”, &pThermostatB);
  // get the setpoint property
  LxClassGetPropertyByName(pThermostatA->pClass,
“Setpoint”, &pSetpointProperty);
  // get the Climate Control class
  pClimateClass = pSetpointProperty->pParent;
  // run a web server that combines both thermostats
  LxRunWebServer(pHVACSystem);
  // In our particular application, we want to track
additional information on
  // on each thermostat. We can dynamically define a
new object type and
  // transform the existing remote thermostats to use a
new type.
  // in this case, we add a “UserHold” property which
suppresses automatic
  // adjustment from the programmatic schedule
  // create a new class that defines a UserHold property
  // and inherits from ClimateControl
  LxCreate(pTypeClass,  NULL,  “CustomThermostat”,
&pCustomThermostatClass);
  LxCreate(pTypeBoolean,  pTypeClass,  “UserHold”,
&pHoldProperty);
  LxClassInherit(pCustomThermostatClass, pClimateClass);
  // now we transform each thermostat into the new type
  LxTransform(pThermostatA, pCustomThermostatClass);
  LxTransform(pThermostatB, pCustomThermostatClass);
  // Even though we changed the instances'  types,
everything remains running
  // without interruption.  Existing attributes (i.e.
Setpoint) are preserved.
  // put thermostats on a schedule for energy
preservation,
  // run schedule from this PC in an infinite loop
  while(1)
  {
    setpoint = 22;
    GetLocalTime(&nHour, &nMinute, &nSecond);
    if((nHour >= 0 && nHour < 7) ||(nHour > 17 &&
nHour < 24)
    {
      // save energy during non-working hours
      setpoint = 26;
    }
    // adjust the temperature -- send updates to each
device
    // except if the Hold property is set, then don't
update each device
    LxGetPropertyBool(pThermostatA,  pHoldProperty,
&bHold);
    if(!bHold)
      LxSetPropertyFloat(pThermostatA,
pSetpointProperty, setpoint);
    LxGetPropertyBool(pThermostatB,  pHoldProperty,
&bHold);
    if(!bHold)
      LxSetPropertyFloat(pThermostatB,
pSetpointProperty, setpoint);
    // wait 1 minute before checking again
    Sleep(60000);
    }
    return 0;
}
```

Data structures used by the source code above that is run on the device servers 40, 50 and the computer (e.g., PC) 20 are shown below:

typedef enum _LXVARTYPE

{

| | |
|---|---|
| ELEMENT_TYPE_END | = 0x0, |
| ELEMENT_TYPE_VOID | = 0x1, |
| ELEMENT_TYPE_BOOLEAN | = 0x2, |
| ELEMENT_TYPE_CHAR | = 0x3, |
| ELEMENT_TYPE_I1 | = 0x4, |
| ELEMENT_TYPE_U1 | = 0x5, |
| ELEMENT_TYPE_I2 | = 0x6, |
| ELEMENT_TYPE_U2 | = 0x7, |
| ELEMENT_TYPE_I4 | = 0x8, |
| ELEMENT_TYPE_U4 | = 0x9, |
| ELEMENT_TYPE_I8 | = 0xa, |
| ELEMENT_TYPE_U8 | = 0xb, |
| ELEMENT_TYPE_R4 | = 0xc, |
| ELEMENT_TYPE_R8 | = 0xd, |
| ELEMENT_TYPE_STRING | = 0xe, |
| ELEMENT_TYPE_PTR | = 0xf, |
| ELEMENT_TYPE_BYREF | = 0x10, |
| ELEMENT_TYPE_VALUETYPE | = 0x11, |
| ELEMENT_TYPE_CLASS | = 0x12, |
| ELEMENT_TYPE_ARRAY | = 0x14, |
| ELEMENT_TYPE_TYPEDBYREF | = 0x16, |
| ELEMENT_TYPE_I | = 0x18, |
| ELEMENT_TYPE_U | = 0x19, |
| ELEMENT_TYPE_FNPTR | = 0x1B, |
| ELEMENT_TYPE_OBJECT | = 0x1C, |
| ELEMENT_TYPE_SZARRAY | = 0x1D, |

```
} LXVARTYPE;
// object flags
#define FLAG_HIDDEN  0x01
#define FLAG_READONLY  0x02
// memory flags
#define MEMFLAG_OBJECT  0x01 // denotes an object for
memory management
#define MEMFLAG_FIELD  0x02 // denotes a field for
memory management
#define MEMFLAG_ARRAY  0x04 // denotes an array for
memory management
#define MEMFLAG_FINALIZE  0x10 // object contains a
finalizer
#define MEMFLAG_KEEPALIVE  0x20 // object is marked
permanent
#define MEMFLAG_PINNED  0x40 // object is currently
pinned
#define MEMFLAG_ROOTED  0x80 // object is currently
rooted
typedef BYTE LXMEMFLAGS;
struct LX_ARG
{
  union
  {
```

| | |
|---|---|
| BOOL | vBoolean; |
| char | vChar; |
| char | vI1; |
| unsigned char | vU1; |
| short | vI2; |
| unsigned short | vU2; |
| long | vI4; |
| unsigned long | vU4; |
| float | vR4; |
| char* | pString; |
| void* | pPtr; |
| LX_VALUE* | pByRef; |
| LX_OBJECT* | pValueType; |
| void* | pMdArray; |
| LX_VALUE* | pTypedByRef; |
| short | vI; |
| unsigned short | vU; |
| void* | pFnPtr; |
| LX_OBJECT* | pObject; |
| LX_ARRAY* | pArray; |

```
  };
};
struct LX_VALUE // 8
{
  LXMEMFLAGS  MemFlags;// ( 1) memory flags
  LXVARTYPE  vt;  // ( 1) raw data type
  WORD  cbSize; // ( 2) sizes of
variable-length values
  LX_ARG  arg; // ( 4) actual data
};
struct LX_ARRAY // 4 + 4*n
{
  LXMEMFLAGS MemFlags; // ( 1) memory flags
  LXVARTYPE  vt; // ( 1) raw data type
  WORD  cElements; // ( 2) number of
elements in array
  LX_ARG  members [1]; // (4X) array members
};
struct LX_FIELD // field, 16
{
  struct LX_VALUE value; // ( 8) the value
  struct LX_FIELD* pNextField;  // ( 4) the next
property value for object  struct LX_OBJECT* pProperty;
  // ( 4) the property
};
struct LX_OBJECT // object, 32
{
```

| | | |
|---|---|---|
| CORMEMFLAGS | MemFlags; | // ( 1) memory flags |
| BYTE | Flags; | // ( 1) object flags |
| WORD | wLocalID; | // ( 2) local id of |

```
object
  struct LX_OBJECT* pParent;  // ( 4) the parent of
the object
  struct LX_OBJECT* pFirstChild;  // ( 4) the first
child of the object
  struct LX_OBJECT* pLastChild;  // ( 4) the last
child of the object
  struct LX_OBJECT* pPrevSibling; // ( 4) previous
sibling in chain
  struct LX_OBJECT* pNextSibling; // ( 4) next sibling
in chain
  struct LX_OBJECT* pClass;  // ( 4) the class of
the object
  struct LX_FIELD*  pFirstField;  // ( 4) points to
first property value
};
struct LX_GUID // globally unique ID 32
{
    unsigned short Data1Lo;
    unsigned short Data1Hi;
    unsigned short Data2;
    unsigned short Data3;
    unsigned char Data4 [ 8 ];
};
```

The system and method described herein uses an object model to represent data of a system, such as a building automation system. Each object may consist of a globally unique identifier that is used to uniquely identify the object within the scope of a network environment. Each object may consist of a name used for describing or referring to it.

The objects may be arranged in a hierarchy, by defining a parent object for each object except for top-level root objects that do not have parents. Each object may be addressed by a path describing its placement within the hierarchy. In exemplary embodiments, the path is constructed by concatenating names of parent objects with delimiters such as a forward slash.

The class of an object defines the type of object, and is itself an object. Each object consists of 0-n fields that describe current data settings, and each field maps to a property. The definition of a field, called a property, is defined as a child object of the class where it resides, and each class may consist of 0-n properties. The class of a property object describes an elementary type, which defines the data size, format, presentation, and behavior.

Classes may support multiple inheritance of 0-n other classes by defining special types of child objects that each contain an object reference field to the inherited class. Classes support extending other classes (inheritance in the reverse order) by defining a special type of child object that contains an object reference field to the class to be extended. Classes may define rules that describe which classes of objects may be created as child objects of instances of classes, by defining a special type of child object that contains an object reference field to the associated class.

The object hierarchy may be modified in a running system while preserving referential data integrity. This includes the modification of any of the items described above with the exception of the globally unique identifier.

The object hierarchy may be manipulated in its entirety by a set of fundamental actions which include: creating an object, deleting an object, setting a field on an object, clearing a field on an object, moving an object by changing its parent and/or position among siblings, and transforming an object by changing its type.

These actions may be nested into transactions to ensure that either all actions must be competed or none completed, guaranteeing data integrity in the event of network or power failure. Additional actions that may be used in connection with those actions described above include: opening a transaction, and closing a transaction. In exemplary embodiments, all actions are remembered to enable auditing of the system or restoring the system to a state at a given point in time. Preferably, the state of the object model is saved periodically to non-volatile storage (“complete save”), and the actions are saved to non-volatile storage immediately as processed (“incremental save”), enabling the current system state to be restored in the event of a power failure or reset, by re-applying the list of actions that occurred since the last complete save. The state of the system can be restored to a previous state by generating “equal and opposite” actions to cancel the effect of each action that is to be reversed.

The object model described herein to represent data of a system, such as a building automation system, is a distributed object model. Network protocols may be used to accomplish changes to the object model. Such protocols may be industry standard protocols or proprietary protocols. Such protocols may be used in various physical connections such as ethernet, serial, wireless, or infrared. Such protocols may be specific to a given device, or device-independent to support any device where the nature of the device is not known in advance, example protocols which include Universal Plug and Play, Jini™, and Simple Object Access Protocol.

Such protocols may be data-centric such as those listed above, or presentation-centric such as hyper text markup language (HTML) or wireless application protocol (WAP). Data-centric protocols primarily contain raw state information while presentation-centric protocols combine the raw state information with additional information to describe how a user may observe and interact with the data. The protocols may be layered together in a modular fashion such that protocols may be added or removed within a running system. A common use of a system might involve translating from one or more protocols to one or more other protocols in a generic fashion.

Multiple systems may be networked together to share views of the same object hierarchy, and such data changes are replicated between machines over a network.

The network communications topology may be adapted to suit multiple scenarios or a combination of scenarios that include: (a) a client-server topology where nodes defined as clients replicate changes to a server, and a server node replicates changes back to all clients; (b) an n-tier topology where server nodes may also be client nodes to other servers, forming a hierarchy of state replication; (c) a broadcast topology where nodes broadcast changes to the network where other nodes listen for such changes; (d) a chain topology where each node replicates changes to one other node, forming a circle of nodes(e) a redundant topology where nodes may be clustered together such all nodes within a cluster replicate state amongst themselves and if one node fails, then another node assumes its place.

Replication conflicts may be resolved at data concentration nodes (such as servers). Such replication conflicts include: (a) modifying deleted objects wherein changes that refer to deleted objects are discarded; (b) moving objects relative to deleted objects wherein if the new parent is deleted, then the change is discarded. If the move defines a relative sibling and the sibling is deleted, the move still occurs but is placed as the last sibling within the location; (c) order convergence where a client node C1 creates object O1 at time T0, designated as action A1. A client node C2 creates object O2 at time T0, designated as action A2. Server node S receives indication of action A1 and reflects notifications back to clients C1 and C2 at time T1. Server node S receives indication of action A2 and reflects notifications back to clients C1 and C2 and time T2. At this point in time (T2), client C1 correctly perceives that O1 was created first and O2 follows, while C2 incorrectly perceives that O2 was created first and O1 follows. To ensure order consistency, server S sends a subsequent re-order notification to client C2 to correct for this aberration caused by communication latency.

A web site may be automatically generated to reflect the contents of the object model.

In exemplary embodiments, a set of C-based application program interfaces (APIs) are defined for the system. An exemplary set of APIs is shown below:

```
int LxCreate(
  struct LX_OBJECT* pClass,
  struct LX_OBJECT* pParent,
char* pszName,
  struct LX_OBJECT** ppInstance);
int LxDelete(
  struct LX_OBJECT* pInstance);
int LxMove(
  struct LX_OBJECT* pInstance,
  struct LX_OBJECT* pParent,
  struct LX_OBJECT* pInsert);
int LxGetProperty(
  struct LX_OBJECT* pInstance,
  struct LX_OBJECT* pProperty,
  struct LX_VALUE** ppValue);
int LxSetProperty(
  struct LX_OBJECT* pInstance,
  struct LX_OBJECT* pProperty,
  struct LX_VALUE* pValue);
int LxClearProperty(
  struct LX_OBJECT* pInstance,
  struct LX_OBJECT* pProperty);
int LxGetGlobalID(
  struct LX_OBJECT* pInstance,
  struct LX_GUID* pGlobalID);
int LxSetGlobalID(
  struct LX_OBJECT* pInstance,
  struct LX_GUID* pID);
int LxGetObjectByPath(
  struct LX_OBJECT* pParent,
  char* pszPath,
  struct LX_OBJECT** ppInstance);
int LxGetObjectByName(
  struct LX_OBJECT* pParent,
  char* pszName,
  struct LX_OBJECT** ppInstance);
int LxGetObjectByGlobalID(
  struct MID* pguid,
  struct LX_OBJECT** ppInstance);
int LxGetObjectByLocalID(
  WORD wLocalID,
  struct LX_OBJECT** ppInstance);
int LxGetFieldByName(
  struct LX_OBJECT* pObject,
  char* pszPropertyName,
  struct LX_FIELD** ppField);
int LxTransform(
  struct LX_OBJECT* pObject,
  struct LX_OBJECT* pClass);
int LxClassGetPropertyByName(
  struct LX_OBJECT* pClass,
  char* pszPropertyName,
  struct LX_OBJECT** ppProperty);
int LxClassInherit(
  struct LX_OBJECT* pClass,
  struct LX_OBJECT* pInheritClass);
int LxQueryClassType(
  struct LX_OBJECT* pClass,
  struct LX_OBJECT* pInheritClass);
int LxSetName(
  struct LX_OBJECT* pInstance,
  char* pszName);
char* LxGetName(
  struct LX_OBJECT* pInstance);
char* LxGetPath(
  struct LX_OBJECT* pInstance);
int LxSystemInit( );
```

In an exemplary embodiment, automatic generation of a website to reflect the type information of an object hierarchy as described above uses the following API.

int LxRunWebServer(
struct LX_OBJECT* pObject);

A device-independent network protocol that facilitates connectivity between nodes in a generic fashion and having replication conflict resolution as described as described above may be defined. An example of such a network protocol is shown below:

struct PSYSCMD_ADD //(32) // object created
{

| | |
|---|---|
| struct LX_GUID idClass; | // 16 |
| struct LX_GUID idParent; | // 16 |
| }; | |

struct PSYSCMD_DEL //( 0) // object deleted
{

| | |
|---|---|
| struct LX_GUID idClass; | // 16 |
| struct LX_GUID idParent; | // 16 |
| }; | |

struct PSYSCMD_VAL //(24) // simple value change
(boolean, number, date, unit)
{

| | |
|---|---|
| struct LX_GUID idProperty; | // 16 |
| struct LX_VALUE Value; | // 8 |
| }; | |

struct PSYSCMD_DYN //(32) // dynamic-size value change
(text, picture)
{

| | |
|---|---|
| struct LX_GUID idProperty; | // 16 |
| WORD wEncoding; | |
| WORD wSequence; | |
| }; | |

struct PSYSCMD_REF //(32) // reference value change
{

| | |
|---|---|
| struct LX_GUID idProperty; | // 16 |
| struct LX_GUID idRefObject; | // 16 |
| }; | |

struct PSYSCMD_CLR
{

| | |
|---|---|
| struct LX_GUID idProperty; | // 8 |
| }; | |

struct PSYSCMD_MOV //(32) // object moved
{

| | |
|---|---|
| struct LX_GUID idInsert; | // 16 |
| struct LX_GUID idParent; | // 16 |
| }; | |

struct PSYSCMD_TXO //(24) // transaction open
{

| | |
|---|---|
| struct LX_GUID idTransaction; | // 16 // id of |

```
transaction
  WORD TranCodeLo;
  WORD TranCodeHi;
  WORD ActionsHi; // total # of actions inside
  WORD ActionsLo; // total # of actions inside
};
struct PSYSCMD_TXC  //(16) // transaction close
{
  struct LX_GUID idTransaction; // 16 // id of
transaction
};
struct PSYSCMD_SSO  //(16) // session open
{
  struct LX_GUID idSession;  // 16 // id of session
  struct LX_GUID idSessionClass; // 16 // class of
requested session
};
struct PSYSCMD_SSC //(16) // session close
{
struct LX_GUID idSession;
};
#define PSYS_COMMAND_VAL 0x11 // set fixed-size property
#define PSYS_COMMAND_REF 0x12 // set reference property
#define PSYS_COMMAND_DYN 0x13 // set dynamic-size property
#define PSYS_COMMAND_CLR 0x14 // clear property
#define PSYS_COMMAND_ADD 0x21 // create object
#define PSYS_COMMAND_MOV 0x22 // move object
#define PSYS_COMMAND_INS 0x23 // insert object
#define PSYS_COMMAND_DEL 0x24 // delete object
#define PSYS_COMMAND_TXO 0x40 // open transaction
#define PSYS_COMMAND_TXC 0x41 // close transaction
#define PSYS_COMMAND_TXR 0x42 // cancel transaction
#define PSYS_COMMAND_SSO 0x80 // open session
#define PSYS_COMMAND_SSC 0x81 // close session
struct PSYSCMD
{
  WORD wSize; // 2 // size of command
  BYTE CommandType; // 1 // type of command
  BYTE ControlCode; // 1 // context of command
  struct LX_GUID idObject;  // 16 // id of relevant
object
  union  // 32 // change info,
varies based on CommandType
  {
    struct PSYSCMD_ADD cmdADD;
    struct PSYSCMD_DEL cmdDEL;
    struct PSYSCMD_VAL cmdVAL;
    struct PSYSCMD_DYN cmdDYN;
    struct PSYSCMD_REF cmdREF;
    struct PSYSCMD_CLR cmdCLR;
    struct PSYSCMD_MOV cmdMOV;
    struct PSYSCMD_TXO cmdTXO;
    struct PSYSCMD_TXC cmdTXC;
    struct PSYSCMD_SSO cmdSSO;
    struct PSYSCMD_SSC cmdSSC;
  };
};
```

The particular embodiment shown and described demonstrates an HVAC system using a network of modular hardware and software components. While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. A method of representing an object in a networked environment, the object representing a device that is a component of a networked system, the method comprising:
(a) defining an initial application specific class;
(b) creating the object from the initial application specific class;
(c) dynamically creating a new application specific class; and
(d) dynamically transforming the object from the initial application specific class to the new application specific class.

2. The method of claim 1, wherein there are a plurality of application specific classes and a plurality of objects, and the method further comprises:
(e) defining a parent object for the object; and
(f) arranging the objects in an object hierarchy based off of the parent object.

3. The method of claim 2, wherein the object hierarchy can be modified in a running system while preserving referential data integrity.

4. The method of claim 3, wherein the object hierarchy can be modified using a set of fundamental actions.

5. The method of claim 4, wherein the set of fundamental actions that can be performed on a respective object to modify the object hierarchy comprises:
(a) creating a new object;
(b) deleting one of the objects;
(c) setting a field on one of the objects;
(d) clearing a field on one of the objects;
(e) moving one of the objects by changing the object's parent and/or the object's position among siblings; and
(f) transforming one of the objects by changing the object's application specific class.

6. The method of claim 5, wherein a plurality of the fundamental actions may be nested into a transaction which ensures that either all actions in the transaction are completed or none of the actions in the transaction are completed so that data integrity is guaranteed in the event of a failure.

7. The method of claim 6, wherein the failure is a network failure.

8. The method of claim 6, wherein the failure is a or a power failure.

9. The method of claim 6, wherein the set of fundamental actions further comprises:
(g) opening a transaction; and
(h) closing a transaction

10. The method of claim 9, wherein all actions are logged to enable auditing of the networked system so that the networked system may be restored to a state at a given point in time.

11. The method of claim 10, wherein a complete save is performed by periodically saving the state of the networked system to non-volatile storage, and by performing an incremental save by saving the actions to non-volatile storage immediately as processed so that the current system state of the networked system can be restored by re-applying the actions of the incremental save that occurred since the last complete save.

12. The method of claim 10, wherein the state of the networked system can be restored to the state at the given point in time by generating equal and opposite actions to cancel the effect of each action that is to be reversed.

13. The method of claim 4, wherein multiple systems may be networked together to share views of the same object hierarchy, and such data changes are replicated between machines over a network.

14. The method of claim 13, wherein the replication uses a client-server topology wherein nodes defined as clients replicate changes to a server, and a server node replicates changes back to all clients.

15. The method of claim 13, wherein the replication is an n-tier topology wherein server nodes can also be client nodes to other servers, forming a hierarchy of state replication.

16. The method of claim 13, wherein the replication is a broadcast topology wherein nodes broadcast changes to the networked system where other nodes listen for such changes.

17. The method of claim 13, wherein the replication is a chain topology wherein each node replicates changes to one other node, forming a circle of nodes.

18. The method of claim 13, wherein the replication is a redundant topology wherein nodes are clustered together such all nodes within a cluster replicate state amongst themselves and if one node fails, then another node assumes its place.

19. The method of claim 4, wherein a network protocol is used to accomplish the object hierarchy modification.

20. The method of claim 19, wherein the network protocol is an industry standard protocol.

21. The method of claim 19, wherein the network protocol is a proprietary protocol.

22. The method of claim 19, wherein the network protocol is a data-centric protocol.

23. The method of claim 19, wherein the network protocol is a presentation-centric protocol.

24. The method of claim 1, wherein a web site is automatically generated to reflect contents of the object.

25. The method of claim 1, wherein a C-based application is used to implement the method.

26. The method of claim 1, wherein the objects are represented using a data structure comprising:
(a) a globally unique identifier, used to uniquely identify the object within the networked system;
(b) a name used for referring to the object;
(c) if the object is not a top-level root object that does not have a parent,
a parent object used to arrange the object within a hierarchy of objects;
(d) a path for addressing the object by describing its placement within the hierarchy of objects;
(e) a class defining a type of the object;
(f) at least one field that describes a current data setting; and
(g) at least one property, wherein each property defines a field and the property is defined as a child object of the class where it resides, wherein each field is mapped to a respective property.

27. A system for representing an object in a networked environment, the system comprising:
a device server in communication with a device;
a network;
a client computer in communication with the device server via the network;
the device server and the client computer each having an initial application specific class defined that includes properties that are representative of the device and an object instance of the initial application specific class; and
wherein, a new application specific class can dynamically be created to represent a change in the device and the object instance can dynamically be transformed from the object instance of the initial application specific class to an object of the new application specific class.

28. The system of claim 27, wherein the client computer includes a display for displaying a user interface that allows a user to view at least one of the properties that are representative of the device.

29. The system of claim 27, wherein the client computer includes a display for displaying a user interface that allows a user to enter data for at least one of the properties that are representative of the device, wherein the entered data is sent to the device via the device server.

30. The system of claim 27, wherein there are a plurality of device servers with each device server in communication with a respective device.

31. The system of claim 27, further comprising a touchpad in communication with the device server, the touchpad configured to remotely communicate with the device.

32. The system of claim 27, wherein communication over the network is performed using a network protocol.

33. The system of claim 32, wherein the network protocol is an industry standard protocol.

34. The system of claim 32, wherein the network protocol is a proprietary protocol.

35. The system of claim 32, wherein the network protocol is a data-centric protocol.

36. The system of claim 32, wherein the network protocol is a presentation-centric protocol.

37. The system of claim 27, wherein the network is an ethernet network.

38. The system of claim 27, wherein the network is a serial network.

39. The system of claim 27, wherein the network is a wireless network.

40. The system of claim 27, wherein the network is an infrared network.
